(19) United States
(12) Patent Application Publication
(10) Pub. No.: US 2025/0227200 A1
(43) Pub. Date: Jul. 10, 2025

(54) Sensory Configurations for Enabling Autonomous Navigation

(71) Applicant: Vayu Robotics, Inc., Palo Alto, CA (US)

(72) Inventors: Anand Gopalan, Foster City, CA (US); Mahesh Krishnamurthi, Saratoga, CA (US); Rajanatha Shettigara, San Jose, CA (US)

(73) Assignee: Vayu Robotics, Inc., Palo Alto, CA (US)

(21) Appl. No.: 19/011,367

(22) Filed: Jan. 6, 2025

Related U.S. Application Data
(60) Provisional application No. 63/618,206, filed on Jan. 5, 2024.
(60) Provisional application No. 63/659,240, filed on Jun. 12, 2024.

(51) Int. Cl. H04N 7/06; H04N 7/035; H04N 7/18; H04N 13/194; H04N 23/90

(52) U.S. Cl. CPC H04N 7/06; H04N 7/0352; H04N 7/181; H04N 13/194; H04N 23/90

(57) ABSTRACT

Systems and methods for implementing sensory configurations in accordance with certain embodiments of the invention are illustrated. One embodiment includes an imaging system that includes cameras, wherein each camera includes image sensor(s). The imaging system includes video links, wherein each of the video links is configured to: connect a particular camera to a central processor, and carry power, from the central processor to the particular camera. The imaging system includes a memory that stores instructions for processing image data obtained from the cameras. The central processor is configured to execute the instructions to perform a method. The method aggregates the image data for each camera of the plurality of cameras to produce aggregated image data, using at least one mobile industry processor interface (MIPI) aggregator. The method processes the aggregated image data to produce a set of at least one environmental image.

### CROSS-REFERENCE TO RELATED APPLICATIONS

The current application claims the benefit of and priority under 35 U.S.C. § 119 (e) to U.S. Provisional Patent Application No. 63/618,206, entitled “Sensory Configurations for Enabling Autonomous Navigation,” filed Jan. 5, 2024; and U.S. Provisional Patent Application No. 63/659,240, entitled “Sensory Configurations for Enabling Autonomous Navigation,” filed Jun. 12, 2024. The disclosures of U.S. Provisional Patent Applications Nos. 63/579,207 and 63/659,240 are hereby incorporated by reference in its entirety for all purposes.

### FIELD OF THE INVENTION

The present invention generally relates to autonomous navigation systems and, more specifically, sensor organization and the processing of sensory input.

### BACKGROUND

Various modes of communication can be used to transmit data over varying distances. Serial communication refers to the process of sending data, one bit at a time, sequentially, over a communication channel. Serial communication is generally more cost-effective and reliable (e.g., over longer distances) due to focusing on a singular data line. This is in contrast to parallel communication, where several bits are sent as a whole, on a link with several parallel channels. Parallel communication's primary advantage is its significantly faster data transfer speed due to transmitting multiple bits simultaneously.

### SUMMARY OF THE INVENTION

Systems and methods for implementing sensory configurations in accordance with certain embodiments of the invention are illustrated. One embodiment includes an imaging system. The imaging system includes a plurality of cameras, wherein each camera of the plurality of cameras includes at least one image sensor. The imaging system includes a plurality of video links, wherein each of the plurality of video links is configured to: connect a particular camera of the plurality of cameras to a central processor, and carry power, from the central processor to the particular camera. The imaging system includes a memory, wherein the memory stores instructions for processing image data obtained from the plurality of cameras. The central processor is configured to execute the instructions to perform a method for processing the image data. The method aggregates the image data for each camera of the plurality of cameras to produce aggregated image data, using at least one mobile industry processor interface (MIPI) aggregator. The method processes the aggregated image data to produce a set of at least one environmental image.

In a further embodiment, the method applies the set of at least one environmental image to machine vision-based navigation.

In another embodiment, a particular camera of the plurality of cameras is configured to produce part of the image data by aggregating captured sensor data from each image sensor of the at least one image sensor included in the particular camera.

In a still further embodiment aggregating the captured sensor data is performed by a Mobile Industry Processor Interface (MIPI) aggregator included in the particular camera.

In another further embodiment, a given video link of the plurality of video links includes a Gigabit Multimedia Serial Link (GMSL).

In a further embodiment, aggregating the captured sensor data is performed by a serializer of the GMSL.

In a still further embodiment, the central processor includes a camera expansion board; and the camera expansion board includes at least one deserializer coupled with the serializer.

In a yet further embodiment, an even number of video links, of the plurality of video links, are attached to a given deserializer of the at least one deserializer.

In a still yet further embodiment, the even number of video links are attached to the given deserializer using a singular serial interface.

In a further embodiment, the singular serial interface is a MIPI bus.

In another embodiment, the even number of video links are used to aggregate image data, from corresponding cameras of the plurality of cameras, into a shared video stream.

In a further embodiment, the shared video stream is configured using stereo vision.

In another embodiment, the at least one deserializer is used to integrate at least one additional non-camera sensor into the imaging system.

In a further embodiment, the at least one deserializer is used to apply the at least one additional non-camera sensor to a navigation objective.

In yet another embodiment, the at least one additional non-camera sensor includes at least one of: an inertial measurement unit (IMU); or a three-axis gyroscope.

In another embodiment, the method further includes synchronizing a capture of the at least one additional non-camera sensor with captures of at least some of the plurality of cameras.

In a further embodiment, synchronizing the capture of the at least one additional non-camera sensor with the captures of the at least some of the plurality of cameras includes transmitting a pulse width modulation pulse.

In another embodiment, each image sensor of the at least one image sensor, included in a given camera of the plurality of cameras, includes a personal frequency reference clock. The personal frequency reference clock is monitored by a corresponding video link for the given camera.

In another embodiment, a given image sensor of the at least one image sensor, included in a given camera of the plurality of cameras, includes a personal image signal processor (ISP).

In a further embodiment, the personal ISP and the given image sensor are appended to a shared rigid flex printed circuit board (PCB) appended to the given camera.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an imaging system configured in accordance with some embodiments of the invention.

FIGS. 2A-2C conceptually illustrate camera integration configurations in accordance with numerous embodiments of the invention.

FIGS. 3A-3C illustrate lens configurations constructed in accordance with certain embodiments of the invention.

FIGS. 4A-4I illustrates images obtained using sensory mechanisms configured in accordance with a number of embodiments of the invention.

FIGS. 5A-5B illustrates a printed circuit board used with imaging sensors configured in accordance with certain embodiments of the invention.

FIG. 6 conceptually illustrates a multi-sensor calibration setup in accordance with multiple embodiments of the invention.

### DETAILED DESCRIPTION

Turning now to the drawings, imaging systems and methods for facilitating (e.g., polarization) imaging in accordance with various embodiments of the invention are illustrated. In many embodiments, imaging systems may be configured for purposes including but not limited to capturing polarization cues, which can be used to infer depth information. Systems and methods in accordance with certain embodiments of the invention may enable the combination of outputs from a plurality of image sources into individual serial and/or parallel links including but not limited to Gigabit Multimedia Serial Links (e.g., GMSL, GMSL2, GMSL3).

Imaging systems in accordance with various embodiments of the invention can incorporate any of a variety of sensors including but not limited to (e.g., singlet) image sensors and/or cameras. For example, image sensors incorporated into imaging systems in accordance with multiple embodiments of the invention may utilize certain configurations to incorporate polarization filters into cover glass. Further, in various embodiments, sensors including (but not limited to) laser imaging, detection, and ranging (LIDAR) sensors and/or conventional cameras may be utilized in combination with imaging systems to gather information concerning surrounding environments. In certain embodiments, the sensor(s) used in imaging systems configured in accordance with multiple embodiments of the invention can be periodically maintained using self-supervised calibration.

Imaging systems and methods for maintaining and implementing imaging systems in accordance with many embodiments of the invention are discussed further below.

### A. Imaging Systems

Imaging systems, including but not limited to autonomous robots and/or polarization imaging systems, configured in accordance with various embodiments may be utilized in a variety of applications including but not limited to image-based localization. Autonomous mobile robot configurations in accordance with a number of embodiments of the invention may incorporate functionality that is further enumerated in NVIDIA Jetson Camera Software Solution, NVIDIA Developers Guide, https://docs.nvidia.com/jetson/arc hives/r35.1/DeveloperGuide/text/SD/CameraDevelopment/CameraSoftwareDeveloment Solution.html/, the entire disclosure of which, including the disclosure related to camera architectures, is hereby incorporated by reference in its entirety.

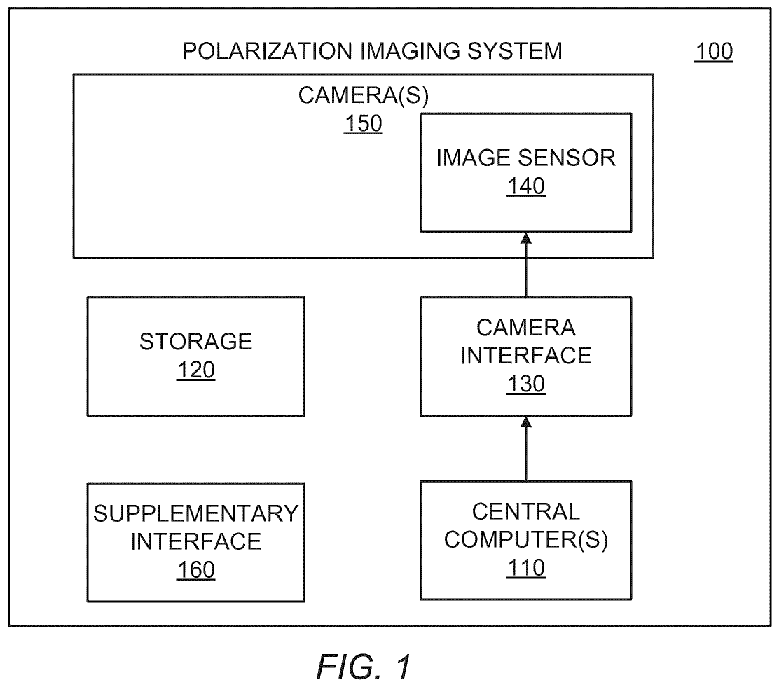

A conceptual diagram of an imaging system configured in accordance with an embodiment of the invention is illustrated in FIG. 1. The imaging system 100 includes (but is not limited to) one or more central computers 110, such as a central processing unit CPU and/or a graphics processing unit (GPU); a data storage 120 component; one or more interface 130, 160 components; one or more cameras 150; and/or one or more image sensors 140.

Hardware-based central computers 110 may be implemented within imaging systems and other devices operating in accordance with various embodiments of the invention. In doing so, the central computers 110 may be configured to execute program instructions and/or software, causing computers to perform various methods and/or tasks, including the techniques described herein. Several functions including but not limited to data processing, data collection, machine learning operations, and/or simulation generation can be implemented on singular processors, on multiple cores of singular computers, and/or distributed across multiple processors.

Central computers 110 may take various forms including but not limited to CPUs, digital signal processors (DSP), core processors within Application Specific Integrated Circuits (ASIC), image signal processors (ISPs), and/or GPUs for the manipulation of computer graphics and image processing. In accordance with many embodiments, central computers may 110 include but are not limited to Jetson AGX Orin central computing units. Central computers 110 may be directed to various polarization and/or localization operations. Central computers 110 may, additionally or alternatively, be coupled with one or more GPUs. GPUs may be directed towards, but are not limited to ongoing perception, sensory, and/or calibration efforts.

Central computers 110 implemented in accordance with numerous embodiments of the invention may be configured to process input data (e.g., camera/image data) according to instructions stored in data storage 120 components. Data storage 120 components may include but are not limited to hard disk drives, nonvolatile memory, and/or other non-transient storage devices. Data storage 120 components, including but not limited to (e.g., volatile, non-volatile) memory, can be loaded with software code that is executable by central computer(s) 110 to achieve certain functions. Memory may exist in the form of tangible, non-transitory, computer-readable mediums configured to store instructions that are executable by the central computer 110. Data storage 120 components may be further configured to store supplementary information including but not limited to sensory, imaging, and/or depth map data.

Supplementary interface 160 components configured in accordance with a number of embodiments may, additionally or alternatively, include various input-output (I/O) elements, including but not limited to flex circuits, parallel and/or serial ports, Universal Serial Buses (USBs), Ethernet, and other ports and/or communication interfaces capable of connecting systems to external devices and components. Additionally or alternatively, supplementary interface 160 components such as network switches may connect devices including but not limited to computing devices; wireless networking (e.g., Wi-Fi) access points; transmitters and/or receivers, such Wi-Fi and Long-Term Evolution (LTE) antennae; and various servers (e.g., in Ethernet local area networks/LANs) to maintain ongoing communication.

Imaging systems configured in accordance with several embodiments may, additionally or alternatively, include one or more peripheral mechanisms (peripherals). Peripherals may include any of a variety of components for capturing data, including but not limited to image sensors (i.e., cameras 150) and/or other sensors (e.g., inertial measurement units (IMUs)). In a variety of embodiments, cameras 150 and/or other sensors can be used to gather input images and/or provide output data maps. Imaging systems configured in accordance with some embodiments of the invention may incorporate a plurality of cameras 150 including but not limited to wide-view cameras, narrow-view cameras, and/or quad cameras. In accordance with some embodiments, at least some of the plurality of cameras may directly interface additional sensors that can be used by imaging systems. Additional sensors configured in accordance with a number of embodiments may include but are not limited to ultrasonic sensors, motion sensors, light sensors, infrared sensors, and/or custom sensors. In some embodiments of the invention, cameras 150 integrated in accordance with several embodiments of the invention may possess one or more image sensors 140. The one or more image sensors 140 may be connected to the central computer(s) 110 through some of the interfaces (i.e., the camera interface 130).

Central computers 110 may be coupled to at least one camera interface 130 component including but not limited to (e.g., Jetson AGX Orin) camera expansion boards and/or serial interfaces. Serial interfaces implemented by imaging systems configured in accordance with various embodiments of the invention may include but are not limited to Display Serial Interfaces following Mobile Industry Processor Interface Protocols (MIPI DSIs). Additionally or alternatively, camera expansion boards in accordance with certain embodiments of the invention may allow for the combination of outputs from a plurality of cameras 150 into individual video links including but not limited to Gigabit Multimedia Serial Links (e.g., GMSL, GMSL2, GMSL3). GMSL configurations have functionality elaborated on GMSL2 Channel Specification User Guide, Analog Devices, Inc., https://www.analog.com/media/en/technical-documentation/user-guides/gmsl2-channel-specification-user-guide.pdf/, the entire disclosure of which, including the disclosure related to camera integration, is hereby incorporated by reference in its entirety.

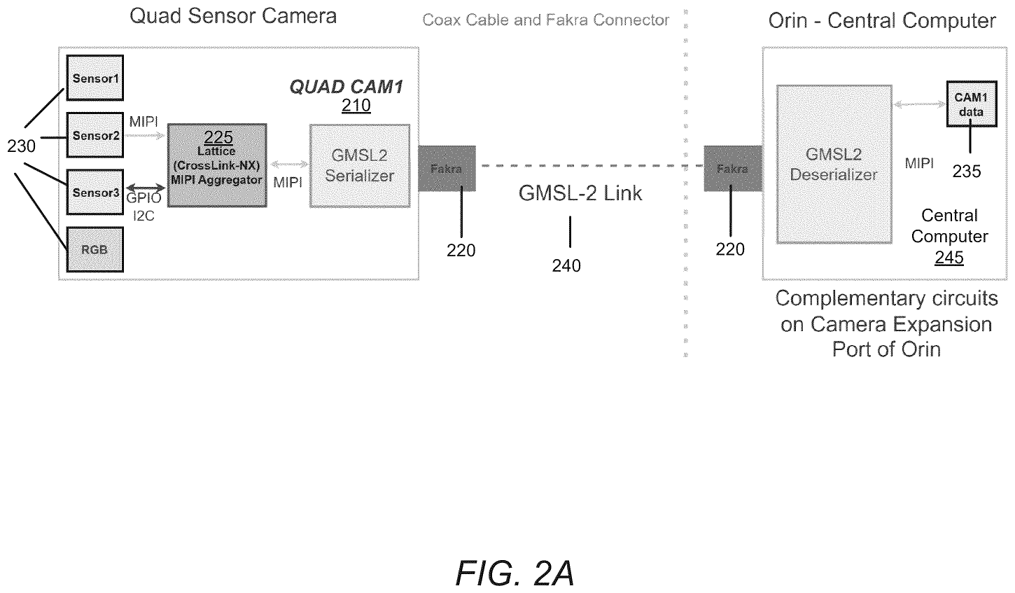

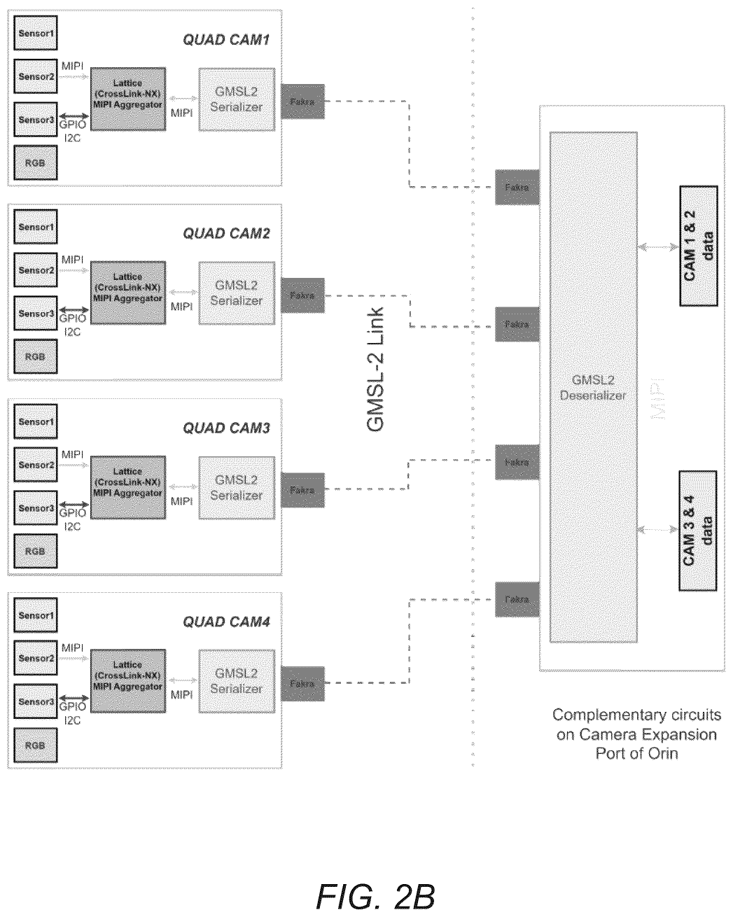

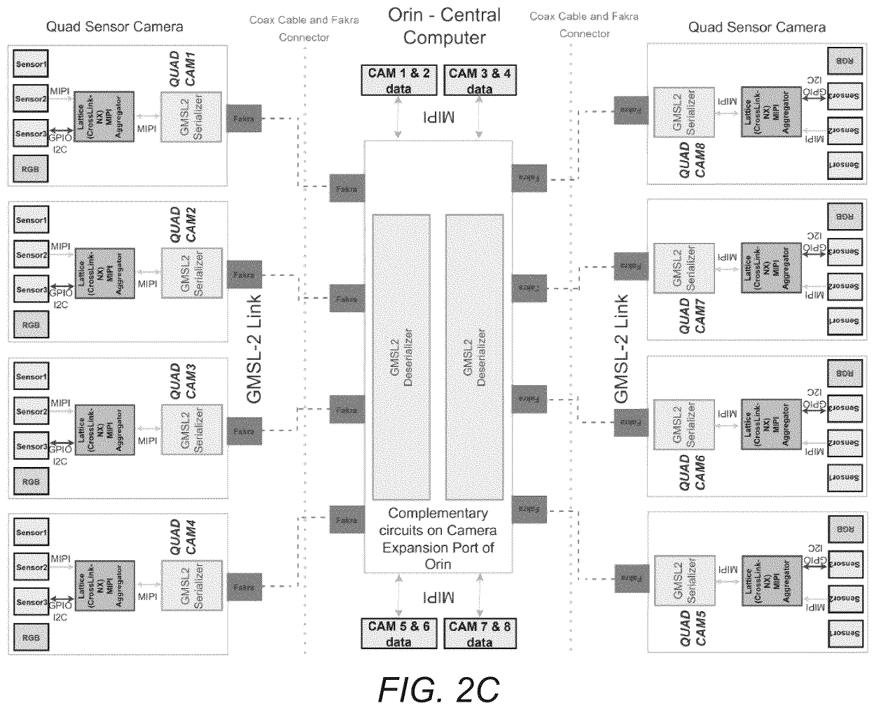

Video link configurations applied in accordance with numerous embodiments of the invention are illustrated in FIGS. 2A-2C. As indicated above, video link 240 configurations may be used to transmit sensory data 235 from cameras 210, including but not limited to quad cameras, to central computers 245, including but not limited to Jetson AGX Orin central (“Orin”) computing units. In accordance with multiple embodiments of the invention, the same video links 240 used to connect the cameras 210 to the central computers 245 may (additionally or alternatively) carry power required for the cameras 210. In such cases, the required power may be carried through the use of power over coax (POC) cables. In accordance with numerous embodiments, the POC cables may have various lengths; for example, in some cases, the cables may be set to have a max length of three meters or less. Additionally or alternatively, power for the POC can be drawn from the (e.g., Orin) central computer itself and/or from different external DC source(s).

In accordance with multiple embodiments, within the cameras 210, sensory data from one or more associated sensors 230 can undergo a first level of aggregation and/or virtual channel creation. Cameras 210 configured in accordance with many embodiments of the invention may aggregate sensor data 235 from multiple (e.g., 4) sensors 230, where the sensor data 235 can be RAW and/or processed. Systems configured in accordance with some embodiments of the invention may use ISPs to process RAW images from the sensor(s) into high-quality image(s) for machine vision and tele-assist (to display the surround vision user). This may be used to save computational power and/or memory (e.g., dynamic random-access memory) of the central computer(s) and/or for the software algorithms used by the system. Additionally or alternatively, this may allow for quick isolation of problems to computer and/or sensor boundaries.

In accordance with some embodiments of the invention, the sensor data 235 may be aggregated prior to reaching the video links 240 using various aggregators including but not limited to MIPI aggregators 225 (e.g., Lattice CrossLink-NX MIPI aggregators). Additionally or alternatively, within the cameras 210, singular serial interface (e.g., MIPI) buses may be used to transmit the sensor data to the video link(s) 240 via serializer. In various embodiments of the invention, serializers may be configured to convert parallel (sensor) data streams (i.e., from the various cameras) to serialized data streams. When GMSL is used alongside Orin computing units, each of the individual GMSL links may be able to accommodate up to sixteen virtual channels/streams. Further, as indicated in FIGS. 2B and 2C, in accordance with various embodiments of the invention, as many as eight different cameras 210 may be connected to the central computer 245 (e.g., using GMSL links 240).

In accordance with multiple embodiments of the invention, the video links 240 may be enabled through the use of components including but not limited to serializers (corresponding to the camera(s) 210), deserializers (corresponding to the central computer(s)), and/or connectors (corresponding to both). In accordance with some embodiments, video links 240 may use easily accessible connectors (e.g., Fakra connectors). In such cases, the (e.g., Fakra) connectors can be quad, dual, and/or single based on logistics and mechanical constraints.

In accordance with various embodiments, camera expansion boards may have (e.g., GMSL) quad deserializers, with four video link inputs and/or two serial interface buses (as depicted in FIG. 2B). In some embodiments of the invention, deserializers may be used to convert serialized (sensor) data to parallel data. In such cases, for quad deserializer-based design, two inputs of the video link (e.g., GMSL) can share singular serial interface (e.g., MIPI) buses. As in FIG. 2B, four GMSL inputs can use the two MIPI buses of the central computer 245. Additionally or alternatively, as in FIG. 2C, systems in accordance with various embodiments may have the central computer 245 be connected to eight different video link inputs/streams. To enable this, systems may have two (or more) GMSL quad deserializers working in tandem with the central computer 245. Additionally or alternatively, in accordance with some embodiments, a pair of quad cameras may be used for stereo vision alongside singular sensor-based cameras to minimize power usage and/or optimize cost.

In accordance with some embodiments, deserializers may, additionally or alternatively, be used to integrate sensors including but not limited to IMUs into imaging systems for purposes including but not limited to navigation. In such cases, the deserializers may manage sensor use through the application of components including but not limited to microcontroller(s) and/or field-programmable gate arrays (FPGAs). When additional sensors are incorporated, systems configured in accordance with certain embodiments may include three-axis gyroscopes to periodically confirm the camera pose(s). Based on the additional sensors (e.g., IMUs), systems may synchronize the additional sensor capture with video capture. Additionally or alternatively, systems may match the additional sensor (e.g., IMU) axis to the camera axis and/or make the Z-axis the optical path.

Systems and methods in accordance with multiple embodiments of the invention may, additionally or alternatively, be configured to synchronize times. In accordance with some embodiments, each of the image sensors may need a specific frequency reference clock, which can be provided/monitored by video links (e.g., GMSL serializers). Additionally or alternatively, the frequency reference clocks can be provided to deserializer boards. In some cases, video link (e.g., GMSL) chipsets may have Reference Over Reverse (RoR) Clock operating modes. Using RoR, serializers may receive reference clocks from deserializers over the video links. RoR can eliminate the need for crystal oscillators on the serializer side of the link. In RoR mode, the serializers' timing reference can be extracted from the signals sent on the reverse channel(s). The recovered clock(s) coming from the deserializers can be used by the serializers' on-chip phase-locked loop (PLL) to synthesize the serializer output reference clock. RoR modes can be automatically supported by serializer configuration.

Through using RoR operative modes, systems configured in accordance with multiple embodiments may send data in a sequential manner as long as capture sequences are retained. Precise mechanisms to achieve this may vary based on image sensors. Additionally or alternatively, central computers including but not limited to Orin central computing units may be able to send pulse width modulation pulses to synchronize all sensors of the systems. In accordance with several embodiments, for each of the frames captured by sensors, headers with time stamps (PTP) may be replaced with frame counters. Additionally or alternatively, when the FPGA resource is available, systems may add 16-bit frame counters to enable the central computer(s) to easily sort out missing frames before forwarding video frames for further processing.

As mentioned above, (wired and/or wireless) interfaces used by systems configured in accordance with multiple embodiments of the invention to communicate with other devices and/or components including but not limited to the image sensors of cameras. Imaging systems can utilize additional interfaces targeted to operations including but not limited to transmitting and receiving data over networks based on the instructions performed by processors, and application of the images to greater configurations. For example, additional interfaces configured in accordance with many embodiments of the invention can be used to integrate imaging systems into greater configurations that may be applied to localizing entities (e.g., in autonomous robots). The aforementioned localizing configurations may be referred to as localization systems in this application.

While specific imaging systems and localization systems are described above with reference to FIGS. 1-2C, any of a variety of imaging system arrangements can be implemented as appropriate to the requirements of specific applications in accordance with various embodiments of the invention. Furthermore, applications and methods in accordance with some embodiments of the invention are not limited to use within any specific imaging systems. Accordingly, it should be appreciated that the system configurations described herein can also be implemented outside the context of imaging systems described above with reference to FIGS. 1-2C. Many systems and methods for performing polarization and/or localization in accordance with numerous embodiments of the invention are discussed further below.

### B. Polarization Imaging

Images that capture information concerning the polarization angles of incident light provide depth cues that can be used to recover highly reliable depth information. Polarization imaging systems and methods of capturing polarization images in accordance with many embodiments of the invention are capable of performing (e.g., single-shot, single-camera) polarization imaging. Furthermore, systems configured in accordance with numerous embodiments of the invention may be based on mass-produced sensors.

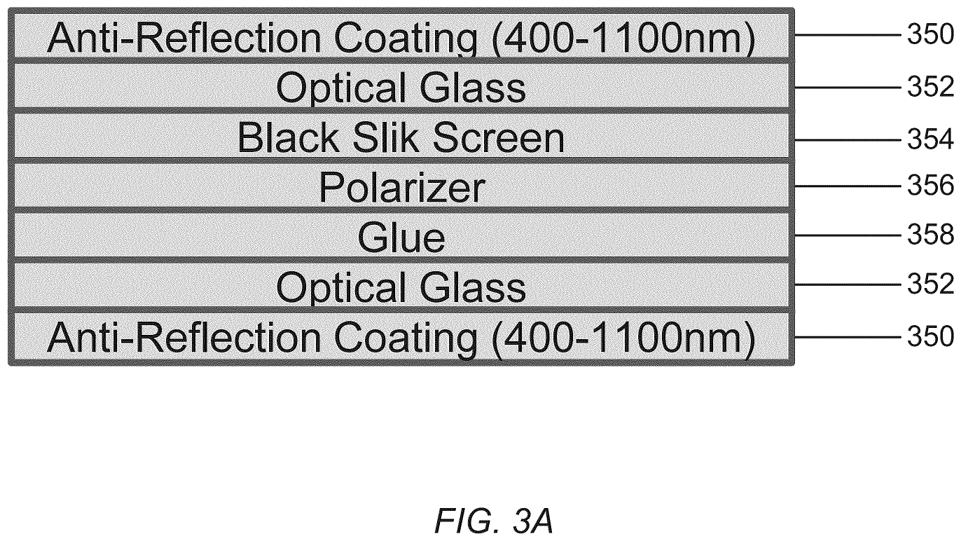

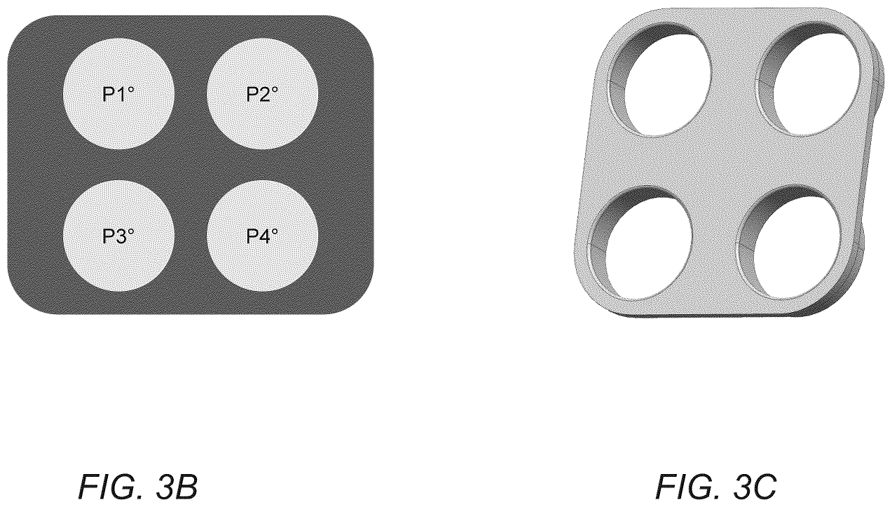

A polarizer configuration in accordance with some embodiments of the invention is conceptually illustrated in FIGS. 3A-3C. As indicated in FIG. 3A, in accordance with multiple embodiments of the invention, the cover glass implemented for polarizers 325 may include, but is not limited to anti-reflection coating 310, optical glass 315, a black silk screen 320, and adhesive 330. In accordance with certain embodiments, the thickness of the total cover glass may be 3 mm with tolerance of +0 mm and −0.2 mm. In accordance with a number of embodiments, anti-reflection coating 310 may be the outermost layer of both sides of the cover glass. The anti-reflection coating 310 may, in certain embodiments, be anywhere from 400 nm-1100 nm thick. One layer inward from the anti-reflection coating 310, both sides of the cover glass may include optical glass 315. In accordance with several embodiments, the optical glass 315 used may include, but is not limited to BK7 glass. One layer inward from the optical glass 315, at least one side of the cover glass may incorporate a black silk screen 320. Additionally or alternatively, one layer after the optical glass 315, at least one side of the cover glass may incorporate an adhesive 330 (e.g., lens glue). At the innermost layer, lenses configured in accordance with some embodiments may have the polarizer filter 325.

While specific layers, orderings of layers, and/or thicknesses of layers for polarizer configurations are described above, systems and methods in accordance with various embodiments of the invention can incorporate any arrangement of layers having any of a variety of thicknesses and/or materials as appropriate to the requirements of specific applications. As such, in certain embodiments, the layers of the polarizer may follow any order and/or sequence, and are not limited to the order and sequence shown and described.

Cover glass configurations in accordance with multiple embodiments of the invention are illustrated in FIGS. 3B and 3C. Polarizers may have apertures (P1°, P2°, P3°, P4°) arranged in the cover glass 2×2. In some embodiments, any two orthogonal apertures may be 29.0 mm±0.05 mm apart center-to-center. In accordance with a few embodiments, the cover glass apertures may each have a diameter of 19.3 mm±0.2 mm. The cover glass, as shown in FIG. 3B, may take the form of rounded rectangles. In such cases, the dimensions may occasionally follow a configuration within (60.9 mm±0.1 mm)×(67.9 mm±0.1 mm). Additionally or alternatively, the cover glass may take various other forms including but not limited to rectangular and oval. The cap for the cover glass, as shown in FIG. 3C, may have lens shrouds (that can also be arranged 2×2), wherein each lens shroud may have a diameter of 19.55 mm±0.05 mm. Finally, in accordance with many embodiments of the invention, the main lens(es) on which the cover glass is placed may have an outer diameter of 18.5 mm±0.1 mm.

While specific cover glass arrangements and measurements are described above, systems and methods in accordance with numerous embodiments of the invention can incorporate any arrangement and/or size measurements as appropriate to the requirements of specific applications.

Main lenses may correspond to multiple types of camera lenses including but not limited to standard lenses and/or specialty lenses. While the main lens is shown here as a single lens, a main lens can be a lens stack including multiple lens elements. Aperture planes in main lenses configured in accordance with numerous embodiments may be divided into areas including but not limited to 2, 4, 8, and 16 sub-aperture areas. Polarization filters may have polarization angle measurements including but not limited to 0°, 45°, 90°, and 135°. As can readily be appreciated, polarization filters in accordance with various embodiments of the invention can be located at any aperture plane appropriate to the requirements of specific applications.

In many embodiments, polarization imaging systems capture polarization cues, which can be used to infer depth information. Polarization images can also provide information concerning light reflections that can be relevant to operations including (but not limited to) entity detection and/or correction of poor lighting. In several embodiments, multiple cameras configured with different polarization filters are utilized in a multi-aperture array to capture images of a scene at different polarization angles. Capturing images with different polarization information can enable the imaging system to generate precise depth maps using polarization cues.

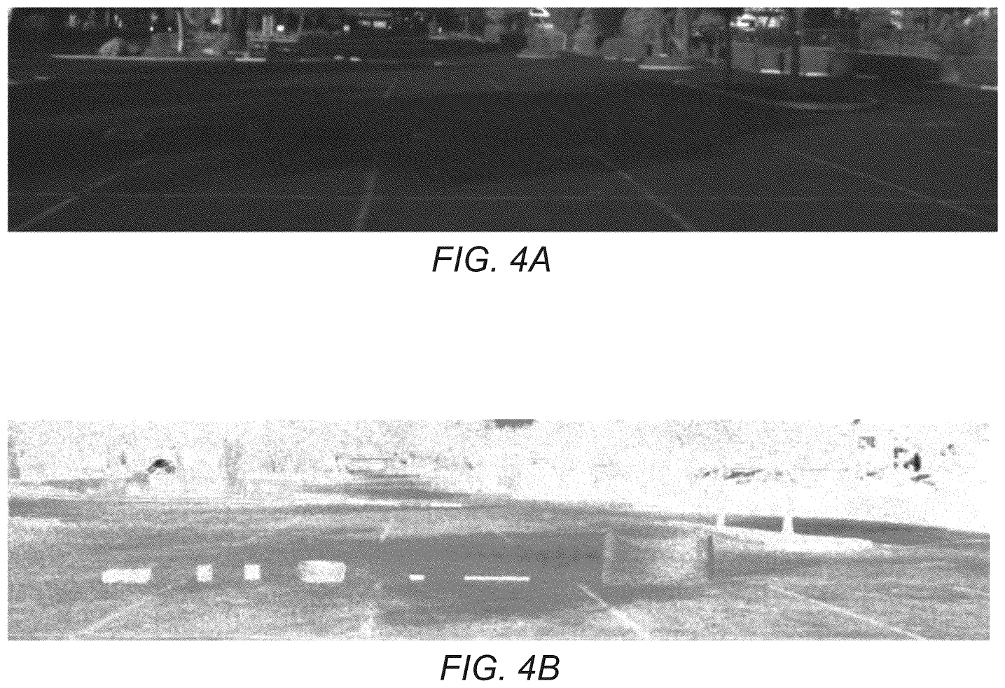

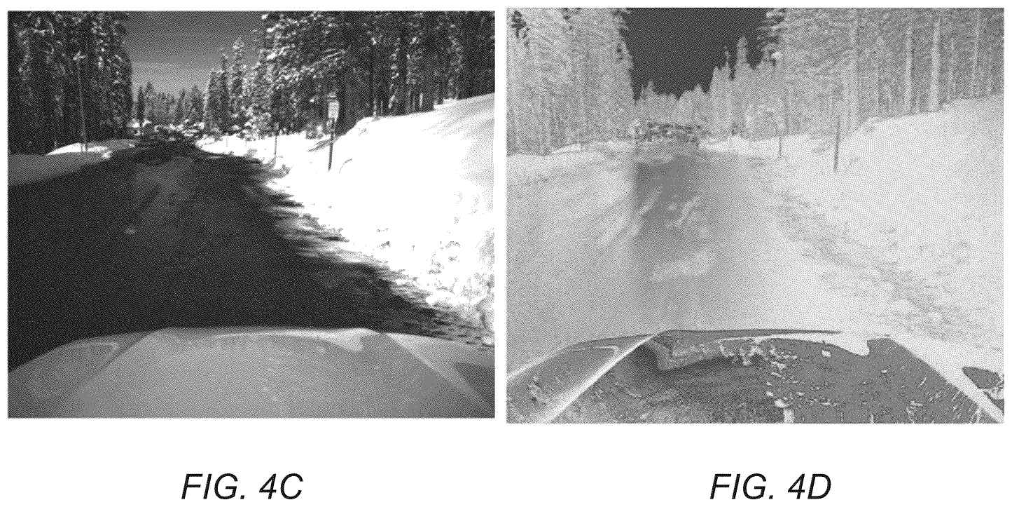

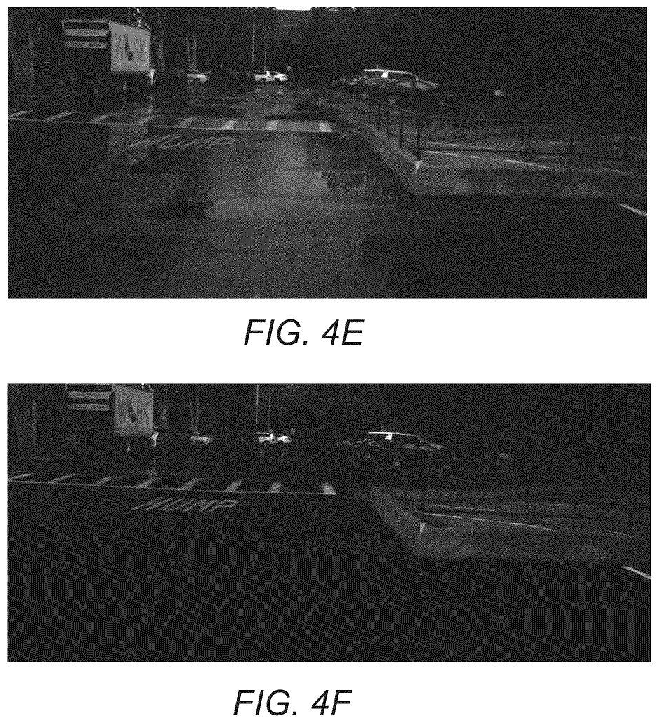

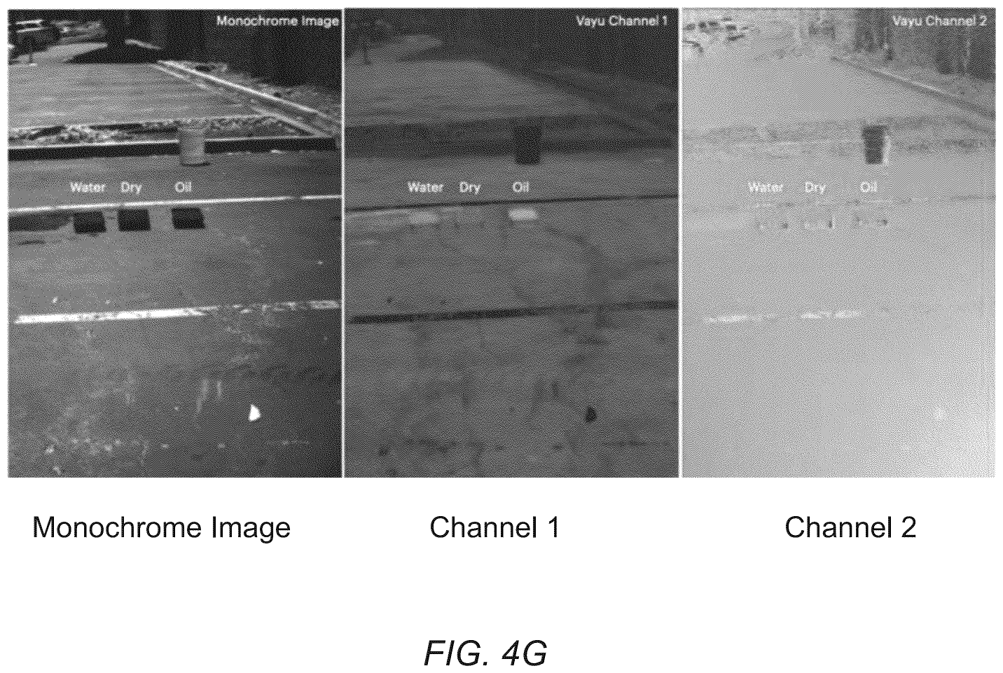

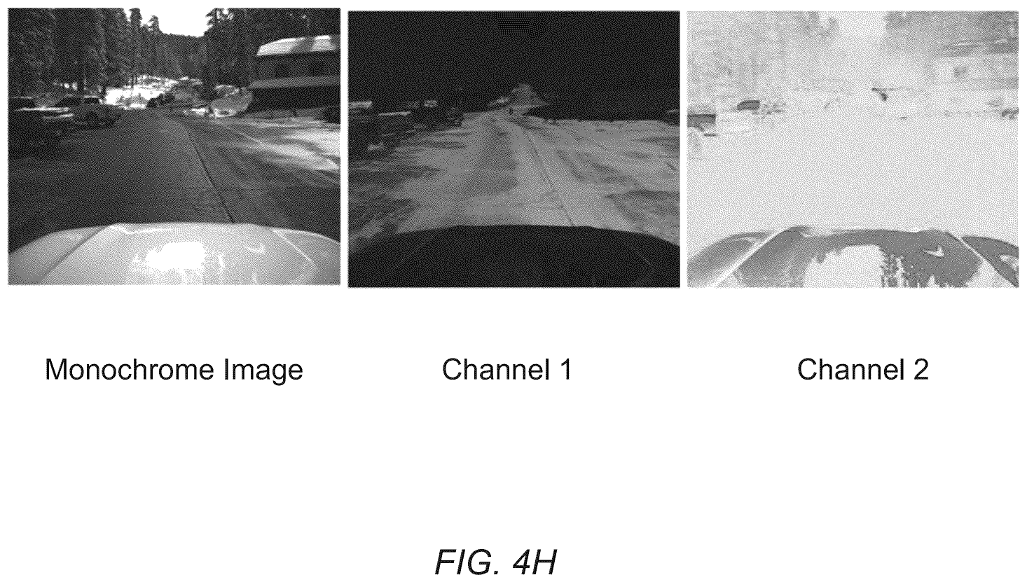

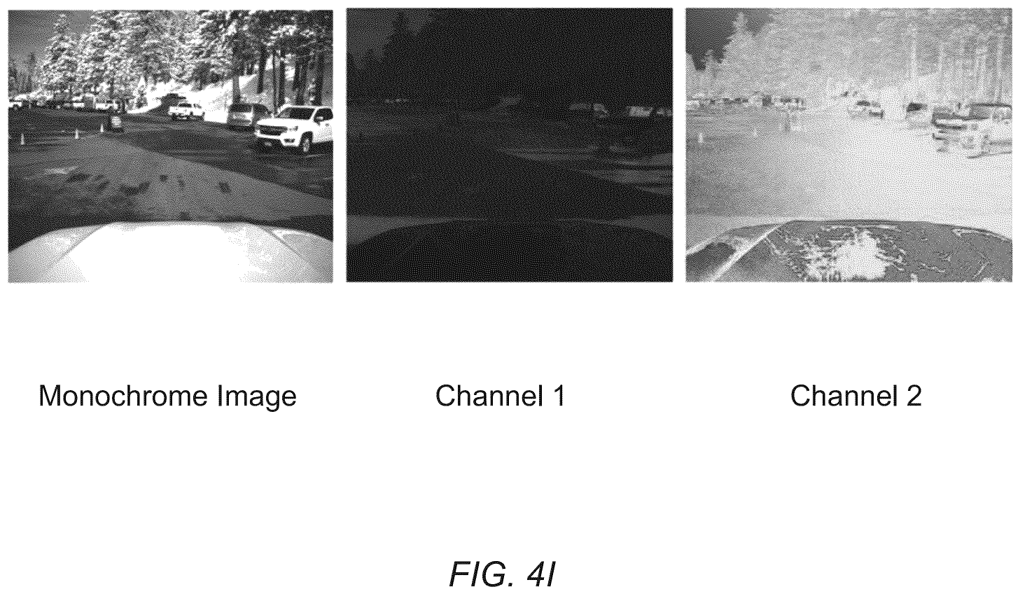

Polarization imaging configurations may be applied to purposes including but not limited to distinguishing road hazards, as is evident in FIGS. 4A-4F. Polarization information can be especially helpful in enabling machine vision applications to modify sensor output. In such cases, polarization sensors may be especially effective when used in analyzing high dynamic range scenes. Referring now to the parking lot depicted in FIG. 4A, the challenges of interpreting an image of a high-dynamic scene containing objects that are in shadow can be appreciated. Specifically, many potential hazards are difficult to identify which, in fast-paced circumstances, can quickly and easily lead to accidents. In contrast, FIG. 4B illustrates an example of an image generated using a polarization imaging system configured in accordance with several embodiments of the invention. This figure emphasizes how clearly objects can be discerned in high dynamic range images using polarization information. Using such systems, various dangers (such as the various hidden objects revealed in FIG. 4B) may be converted to a much easier-to-navigate format.

Systems and methods operating in accordance with certain embodiments of the invention may maximize effectiveness at distinguishing road impediments and/or minimize the danger associated with road distractions. Potential road impediments localized by sensors implemented in accordance with some embodiments of the invention may include but are not limited to but not limited to ice, oil spills, and potholes. The following pair of images illustrate an example of black ice on a partly frozen road being made far more visible by converting the input image of FIG. 4C to an (RGB) polarized image in FIG. 4D. Additionally or alternatively, potential distractions mitigated by sensors may include but are not limited to reflections from standing water, snow, and sun glare. FIGS. 4E and 4F illustrate a second road-based example, here depicting a rainy day. The figures disclose the (often distracting/disorienting) reflections in the standing water being mitigated by polarizing the input image of FIG. 4E to a (greyscale) polarized image in FIG. 4F.

As indicated above, images generated by systems operating in accordance with various embodiments of the invention may be configured using various polarizations and/or (combinations of) channels including but not limited to greyscale and (one or more) RGB channels. In accordance with some embodiments of the invention, a first channel may be used to optimize the identification of material properties. Additionally or alternatively, a second channel may be used to distinguish object shape and/or surface texture. This is reflected in the parking lot depicted in FIG. 4G, wherein the respective impacts of oil and water on a dry surface are emphasized. In channel 1, the brightness that the water and (especially) the oil exhibit compared to the dry surface is fairly pronounced, thereby distinguishing the two materials. Meanwhile, in channel 2, the (liquid) surface texture makes the water-covered and oil-covered areas look fairly consistent with the dry (yet flat) surface, albeit with their respective boundaries evident. As shown in the two roadside examples disclosed in FIGS. 4H and 4I, images generated using various polarizations may (additionally or alternatively) result in images with dampened reflections (e.g., in channel 1) and/or distinguishable areas with more distinct surface textures (e.g., the identifiable snow and ice in channel 2).

While specific examples of the benefits of utilizing polarization imaging systems are described herein with reference to FIGS. 4A-4I, sensor platforms in accordance with embodiments of the invention should be understood as not being limited to the use of any specific polarization imaging system and/or need to incorporate a polarization imaging system at all. Indeed, many localization systems in accordance with various embodiments of the invention utilize sensor platforms incorporating conventional cameras. Additionally or alternatively, image sensors and/or systems (including but not limited to polarization configurations) implemented in accordance with many embodiments of the invention may be incorporated into any of a variety of camera modules, imaging systems, driving systems, and/or localization systems.

### C. Printed Circuit Board Configurations

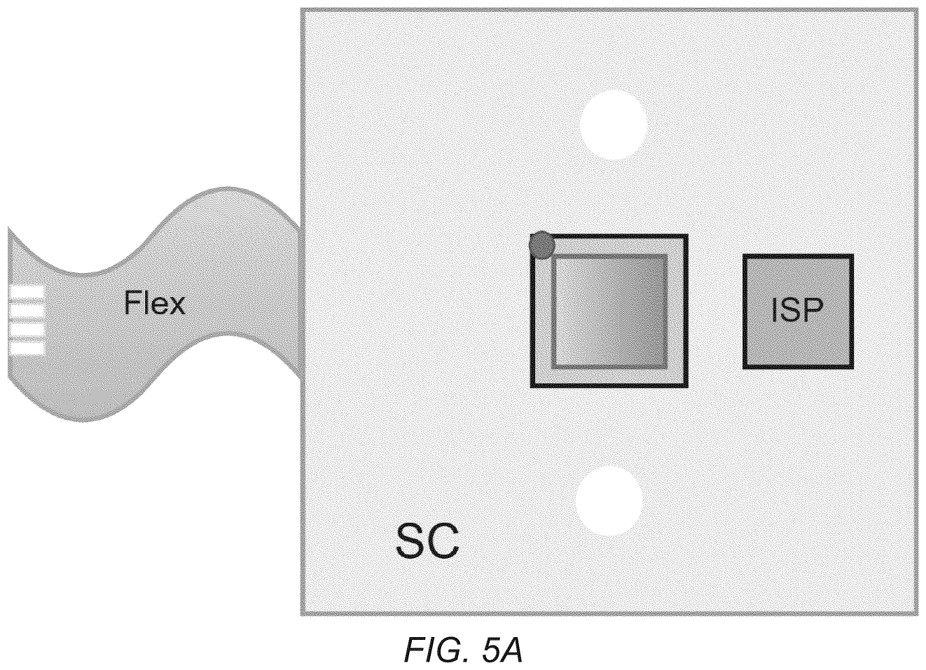

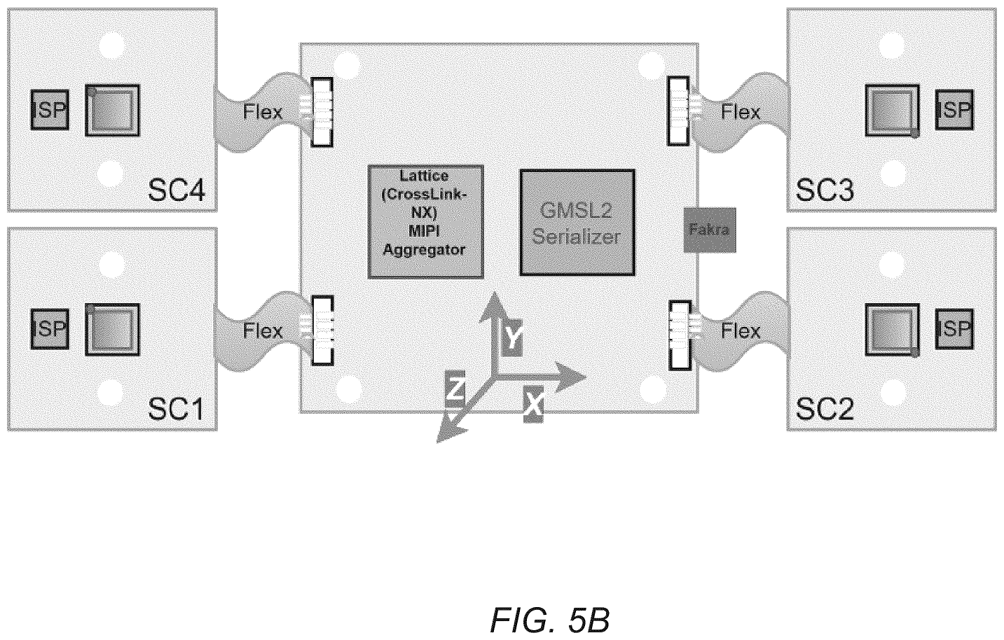

Image sensors including but not limited to the sensors 230 referenced in FIG. 2A, can be integrated into imaging systems configured in accordance with multiple embodiments using rigid flex printed circuit boards (PCBs). A rigid flex PCB configured in accordance with multiple embodiments of the invention is illustrated in FIG. 5A. In accordance with a number of embodiments, PCBs 510 can include but are not limited to an ISP 520 and/or a flex circuit 530. Some of the features of ISPs configured in accordance with multiple embodiments of the invention may include but are not limited to demosaicing, denoising, auto exposure, auto white balancing, tone mapping, gamma correcting, lens shading, color correcting, and/or color domain converting. Additionally or alternatively, instead of being incorporated in the PCB, ISP modules can be incorporated separately on the serializer(s) used for the (e.g., GMSL) video link(s) based on constraints including but not limited to congestion, financial, and/or mechanical. In accordance with many embodiments, most components of PCBs 510 can be mounted on the top side (e.g., using surface-mount technology) of the PCBs as shown in FIG. 5A. In accordance with some embodiments, the flex circuits 530 may be designed using PCB stiffeners. In accordance with multiple embodiments, the back sides of the PCBs may be configured to be flat and/or to be mounted on metal plate (e.g., to enable the use of screws).

Flex circuit 530 length and connection location can be determined by mechanical constraints in accordance with numerous embodiments of the invention. General recommendations may include but are not limited to that: the flex circuit 530 can have enough bend radius for up to 5 GHZ; stress from the flex circuit 530 shall not pop out the connector without any retainers; the design can be conducive to hot bar soldering to optimize the cost; the connector location can be accessible at all times by human figures for easier assembly, faster assembly, and visual inspection while not limited by location of pads and/or connector location; no floating metal on the flex circuit 530 leads to patch antennae; and/or the flex circuit 530 is shielded for electromagnetic compatibility (e.g., emission and susceptibility).

The integration of (four) rigid flex PCBs into an image sensor (e.g., quad camera), in accordance with miscellaneous embodiments of the invention is illustrated in FIGS. 5B. During assembly, PCBs may be constructed and incorporated in the sensor by following the below process:
(1) Mount the PCB 510 on a metal plate per its quadrant assembly. Each of the metal plates may have different precision mounting features to hit the required roll and pitch. Yaw can be a function of the alignment/attachment and metal flatness.
(2) Attach a lens holder (barrel) to the rigid flex PCB through the metal plate. The back side can be flushed based on mechanical requirements.
(3) Connect the video link deserializer to a monitor attached to the Fakra end of the deserializer 550 board (e.g., using the flex circuit 530). With the lens in the holder a picture may be seen on the monitor.
(4) Once the all components in the path are in good condition, follow the active alignment procedure.
(5) Repeat the process for the remaining three PCBs and three quadrants of the sensor.
(6) Use the same (four) sensors and deserializer (board) for the quad camera assembly.

While specific printed circuit board configurations are described above with reference to FIGS. 5A-5B, any of a variety of configurations, arrangements of components, and/or production processes can be utilized for printed circuit boards (including but not limited to rigid flex printed circuit boards) configured in accordance with many embodiments of the invention, as appropriate to the requirements of specific applications.

### D. Sensor Calibration

A variety of sensor systems can be utilized within machine vision applications including (but not limited to) localization systems as described above. In many embodiments, a sensor system utilizing one or more of cameras, time of flight cameras, structured illumination, light detection and ranging systems (LiDARs), laser range finders and/or proximity sensors can be utilized to acquire depth information. Processes for acquiring depth information, and calibrating sensor systems and/or polarized (light) imaging systems in accordance with various embodiments of the invention are discussed in detail below.

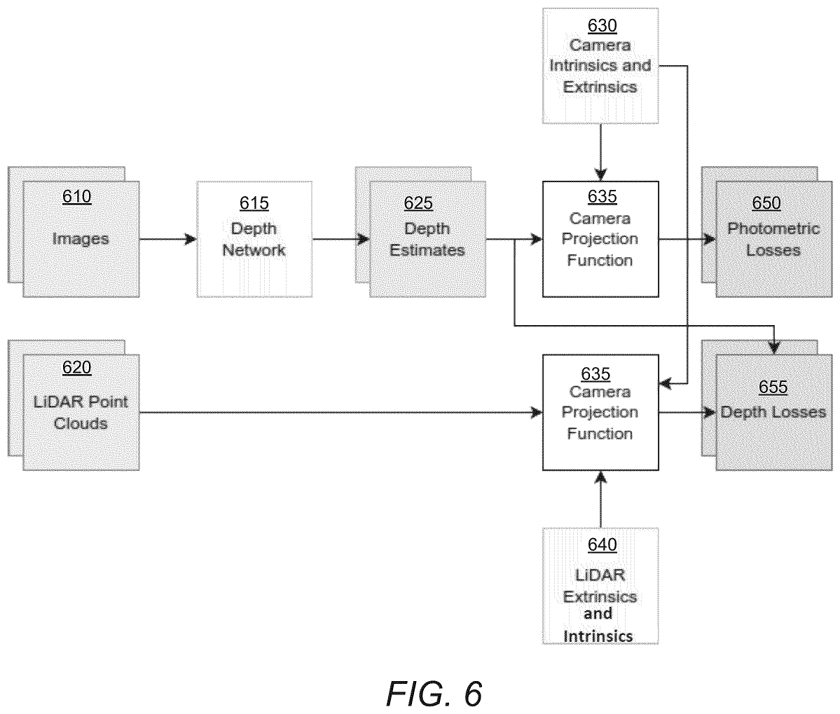

A multi-sensor calibration setup in accordance with multiple embodiments of the invention is illustrated in FIG. 6. Sensor platforms utilized within machine vision systems typically require precise calibration in order to generate reliable information including (but not limited to) depth information. In many applications, it can be crucial to characterize the internal and external characteristics of the sensor suite(s) in use. The internal characteristics of the sensors are typically called intrinsics and the external characteristics of the sensors can be referred to as extrinsics. Machine vision systems and image processing methods in accordance with various embodiments of the invention enable calibration of the internal (intrinsic) and external (extrinsic) characteristics of sensors including (but not limited to) cameras 630 and/or LiDAR systems 640. In accordance with many embodiments of the invention, cameras may produce images 610 of an area surrounding the imaging system.

Additionally or alternatively, LiDAR mechanisms may produce LiDAR point clouds 620 identifying occupied points in three-dimensional space surrounding the imaging system. Utilizing both the images 610 and the LiDAR point clouds 620, the depth/distance of particular points may be identified by camera projection functions 635. In several embodiments, a neural network 615 that uses images and point clouds of natural scenes as input and produces depth information for pixels in one or more of the input images is utilized to perform self-calibration of cameras and LiDAR mechanisms. In accordance with several embodiments, the neural network 615 may take the form of a deep neural network including (but not limited to) a convolutional neural network. Additionally or alternatively, the neural network 615 may be trained using supervised learning techniques that involve estimating the intrinsics and extrinsics of the sensors and the weight of the deep neural network. Specifically, these features may be estimated so that the depth estimates 625 produced from the neural network 615 are consistent with the captured images and/or the depth information contained within the corresponding LIDAR point clouds of the scene.

Calibration processes may implement sets of self-supervised constraints including but not limited to photometric 650 and depth 655 losses. In accordance with certain embodiments, photometric losses 650 are determined based upon observed differences between the images reprojected into the same viewpoint using features such as (but not limited to) intensity. Depth losses 655 can be determined based upon a comparison between the depth information generated by the neural network 615 and the depth information captured by the LiDAR reprojected into the corresponding viewpoint of the depth information generated by the neural network 615. While self-supervised constraints involving photometric and depth losses are described above, any of a variety of self-supervised constraints can be utilized in the training of a neural network as appropriate to the requirements of specific applications in accordance with various embodiments of the invention.

In several embodiments, the implemented self-supervised constraints may account for known sensor intrinsics and extrinsics 630, 640 in order to estimate the unknown values, derive weights for the depth network 615, and/or provide depth estimates 625 for the pixels in the input images 610. In accordance with many embodiments, the parameters of the depth neural network and the intrinsics and extrinsics of the cameras and LiDAR extrinsics may be derived through stochastic optimization processes including but not limited to Stochastic Gradient Descent and/or an adaptive optimizer such as (but not limited to) the AdamW optimizer implemented within the machine vision system (e.g. within a polarization imaging system) and/or utilizing a remote processing system (e.g. a cloud service). Setting reasonable weights for the neural network 615 may enable the convergence of sensor intrinsic and extrinsic 630, 640 unknowns to satisfactory values. In accordance with numerous embodiments, reasonable weight values may be determined through threshold values for accuracy.

Photometric loss may use known camera intrinsics and extrinsics 630, depth estimates 625, and/or input images 610 to constrain and discover appropriate values for intrinsic and extrinsic 630 unknowns associated with the cameras. Additionally or alternatively, depth loss can use the LiDAR point clouds 620 and depth estimates 625 to constrain LiDAR intrinsics and extrinsics 640. In doing so, depth loss may further constrain the appropriate values for intrinsic and extrinsic 630 unknowns associated with the cameras. As indicated above, optimization may occur when depth estimates 625 from the depth network 615 match the depth estimates from camera projection functions 635. In accordance with several embodiments, the photometric loss may additionally or alternatively constrain LiDAR intrinsics and extrinsics to allow for their unknowns to be estimated.

While specific processes for calibrating cameras and LiDAR systems within sensor platforms are described with reference to FIG. 6, any of a variety of online and/or offline calibration processes can be utilized as appropriate to the requirements of specific applications in accordance with various embodiments of the invention. Furthermore, localization systems in accordance with many embodiments of the invention can utilize a variety of sensors including cameras that capture depth cues. As can readily be appreciated, the specific sensors that are utilized within a sensor system depend upon the requirements of a given machine vision application. Imaging systems in accordance with various embodiments of the invention are discussed in detail above.

Embodiments of the present invention should be considered in all respects as illustrative and not restrictive. Accordingly, the scope of the invention should be determined not by the embodiments illustrated, but by the appended claims and their equivalents.

What is claimed is:

1. An imaging system comprising:
a plurality of cameras, wherein each camera of the plurality of cameras comprises at least one image sensor;
a plurality of video links, wherein each of the plurality of video links is configured to:
connect a particular camera of the plurality of cameras to a central processor, and
carry power, from the central processor to the particular camera;
a memory, wherein the memory stores instructions for processing image data obtained from the plurality of cameras; and
the central processor, wherein the central processor is configured to execute the instructions to perform a method for processing the image data, the method comprising:
aggregating the image data for each camera of the plurality of cameras to produce aggregated image data, using at least one mobile industry processor interface (MIPI) aggregator; and
processing the aggregated image data to produce a set of at least one environmental image.

2. The imaging system of claim 1, wherein the method further comprises applying the set of at least one environmental image to machine vision-based navigation.

3. The imaging system of claim 1, wherein a particular camera of the plurality of cameras is configured to produce part of the image data by aggregating captured sensor data from each image sensor of the at least one image sensor included in the particular camera.

4. The imaging system of claim 3, wherein aggregating the captured sensor data is performed by a particular MIPI aggregator included in the particular camera.

5. The imaging system of claim 3, wherein a given video link of the plurality of video links comprises a Gigabit Multimedia Serial Link (GMSL).

6. The imaging system of claim 5, wherein aggregating the captured sensor data is performed by a serializer of the GMSL.

7. The imaging system of claim 6, wherein:
the central processor comprises a camera expansion board; and
the camera expansion board comprises at least one deserializer coupled with the serializer.

8. The imaging system of claim 7, wherein an even number of video links, of the plurality of video links, are attached to a given deserializer of the at least one deserializer.

9. The imaging system of claim 8, wherein the even number of video links are attached to the given deserializer using a singular serial interface.

10. The imaging system of claim 9, wherein the singular serial interface is a MIPI bus.

11. The imaging system of claim 8, wherein the even number of video links are used to aggregate image data, from corresponding cameras of the plurality of cameras, into a shared video stream.

12. The imaging system of claim 11, wherein the shared video stream is configured using stereo vision.

13. The imaging system of claim 7, wherein the at least one deserializer is used to integrate at least one additional non-camera sensor into the imaging system.

14. The imaging system of claim 13, wherein the at least one deserializer is used to apply the at least one additional non-camera sensor to a navigation objective.

15. The imaging system of claim 13, wherein the at least one additional non-camera sensor comprises at least one of:
an inertial measurement unit (IMU); or
a three-axis gyroscope.

16. The imaging system of claim 13, wherein the method further comprises synchronizing a capture of the at least one additional non-camera sensor with captures of at least some of the plurality of cameras.

17. The imaging system of claim 16, wherein synchronizing the capture of the at least one additional non-camera sensor with the captures of the at least some of the plurality of cameras comprises transmitting a pulse width modulation pulse.

18. The imaging system of claim 1, wherein:
each image sensor of the at least one image sensor, included in a given camera of the plurality of cameras, comprises a personal frequency reference clock; and
the personal frequency reference clock is monitored by a corresponding video link for the given camera.

19. The imaging system of claim 1, wherein a given image sensor of the at least one image sensor, included in a given camera of the plurality of cameras, comprises a personal image signal processor (ISP).

20. The imaging system of claim 19, wherein the personal ISP and the given image sensor are appended to a shared rigid flex printed circuit board (PCB) appended to the given camera.
